(19) United States
(12) Patent Application Publication
(10) Pub. No.: US 2010/0051857 A1
(43) Pub. Date: Mar. 4, 2010

(54) NEGATIVE-ELECTRODE ACTIVE MATERIAL FOR SECONDARY BATTERY

(76) Inventors: Hidehiro Takakusa, Tokyo (JP); Minoru Okada, Tokyo (JP); Haruki Wada, Tokyo (JP); Masaji Haneda, Tokyo (JP); Takahiro Osawa, Tokyo (JP)

Correspondence Address: BERENATO & WHITE, LLC, 6550 ROCK SPRING DRIVE, SUITE 240, BETHESDA, MD, 20817, US

(21) Appl. No.: 12/519,629

(22) PCT Filed: Nov. 13, 2007
(86) PCT No.: PCT/JP2007/071971

§ 371 Date: Nov. 2, 2009

(30) Foreign Application Priority Data
Dec. 19, 2006 (JP) 2006-341688

(51) Int. Cl. H01M 4/583

(52) U.S. Cl. 252/182.1

(57) ABSTRACT

A storage battery or a secondary battery is capable of improving the utilization of an active material and obtaining a high energy density, using raw materials having costs substantially equal to those of a conventional lead storage battery especially as a negative-electrode plate of the secondary battery. The negative-electrode active material for the secondary battery is a kneaded mixture including: a raw active material having a metal and an oxide of the metal; and carbon in such an amount that the total absorption number thereof is at least 4.7 ml per mol of the raw active material, in which the kneaded mixture contains no sulfates or sulfates in an amount of 7×10⁻² mol or smaller per mol of the raw active material. The negative-electrode active material has a specific volume of 2.2×10⁻¹ to 5×10⁻¹ ml/g with subjected to no formation. The carbon is acetylene black or furnace carbon.

### BACKGROUND OF THE INVENTION

1. Field of the Invention

The present invention relates to a negative-electrode active material for a secondary battery which has a high energy density and can be manufactured at a low cost.

2. Description of the Related Art

A variety of secondary batteries such as an inexpensive lead storage battery and a high energy-density lithium-ion battery are conventionally known, and needless to say, a secondary battery should ideally be inexpensive and simultaneously have a high energy density. Particularly, a hybrid automobile or an electric automobile started and driven using a storage battery greatly requires an inexpensive high energy-density storage battery. The price of a storage battery depends mostly upon material costs. For example, an expensive nickel-hydrogen storage battery is employed for a hybrid automobile, and nickel used in the positive electrode or a precious metal used in the negative electrode thereof is an extremely high-priced material. A lithium-ion battery also needs an expensive material.

A conventional lead storage battery is generally manufactured by adding dilute sulfuric acid to a raw active material called lead powder obtained by oxidizing lead to thereby form a paste and filling the paste into a grid-shaped current collector. Thereafter, this undergoes formation, and thereby, the positive electrode and the negative electrode include active materials called a lead dioxide and spongy lead, respectively. As the battery discharges, such an active material changes into lead sulfate (discharge active material), and thereby, the volume thereof increases and the pores of a porous structure in the active material become smaller, thereby making it hard to diffuse an electrolyte to the active material.

The active material changes into the lead sulfate as an electric insulator, and thereby, the electric resistance thereof rises. In general, if the lead sulfate exceeds 70%, the electric resistance rises sharply, thereby making it theoretically impossible to conduct a discharge for 70% or more of the active material, in other words, raise the utilization of the active material to 70% or higher. Since it is practically affected by the amount of a discharge current, the utilization is usually approximately 40% in a low-rate discharge while approximately 20% in a high-rate discharge at present.

In order to heighten the utilization of an active material, the specific volume or porosity of the active material needs to be raised. However, it is conventionally known that a rise in the porosity significantly shortens the charge-and-discharge cycle life, and hence, raising the porosity to thereby improve the utilization of the active material is a virtually impossible task and thus remains unsolved.

Although it is preferable that a lead storage battery is made of an inexpensive raw material, the utilization of an active material is lower, thereby requiring a larger amount of lead. This further increases the weight of lead having a relatively high density and thereby lowers the energy density. The present lead storage battery having such an energy density is insufficient and cannot be used for a hybrid car or an electric automobile.

For example, Patent Document 1 (Japanese Patent Laid-Open Publication No. 6-76815) and Patent Document 2 (Japanese Patent Laid-Open Publication No. 2002-63905) offer prior arts of a lead storage battery. Patent Document 1 discloses a manufacturing method of a lead storage-battery anode-electrode plate having a high formation efficiency, a great capacity and a long life. Specifically, it gives the manufacturing method of forming an outer active-material paste layer filled with a kneaded mixture of read lead and water onto an inner active-material paste layer filled with a kneaded mixture of tribasic lead sulfate, read lead and water (or sulfuric acid) to thereby create a wet electrode plate, and drying the wet electrode plate and giving formation thereto. Patent Document 2 capable of lengthening the life of a lead storage battery discloses a negative-electrode paste formed by adding amorphous carbon having a dibutylphthalate absorption number of 100 to 300 ml/100 g of a 0.1 to 0.3 weight-percent to the lead powder and/or sodium lignin sulfonate having a 0.4 to 0.6 weight-percent to the lead powder as a negative-electrode additive to lead powder, dilute sulfuric acid having a 13 weight-percent to the lead powder and water having a 12 weight-percent to the lead powder, and then, kneading and mixing those.

There is a great demand for a secondary battery which is inexpensive and simultaneously has a high energy density, but conventionally, the former is known to be inconsistent with the latter, and hence, this concept has not been realized yet. Both Patent Document 1 and Patent Document 2 have a main object of lengthening the life of a lead storage battery, in other words, aim for a longer life thereof without deteriorating the utilization of an active material as much as possible. Therefore, the arts according to Patent Document 1 and Patent Document 2 obtain merely the existing active-material utilization or so, and thus, cannot realize an active-material utilization beyond 70% capable of obtaining a higher energy density.

As described above, a lead storage battery has a low energy density mainly because the electric resistance thereof rises to thereby hinder raising the utilization to 70% or higher. In addition, the utilization further falls when a discharge is conducted with a greater amount of electric current. Besides, the utilization of an active material is inconsistent with the life, thereby causing a grave problem of shortening the charge-and-discharge cycle life as the utilization becomes higher.

Further, a lithium-ion battery is costly because the material indispensable thereto is expensive, thereby making it difficult to reduce the cost.

### DISCLOSURE OF THE INVENTION

In view of the above problems, it is an object of the present invention to provide a storage battery or a secondary battery capable of obtaining a high energy density using raw materials having costs substantially equal to those of a lead storage battery, and more specifically, a negative-electrode active material for a secondary battery capable of obtaining a higher active-material utilization using an inexpensive raw material as the negative-electrode plate of the secondary battery.

In order to accomplish the object, the present invention offers the following configurations.

A negative-electrode active material for a secondary battery according to claim 1 of the present invention is a kneaded mixture including: a raw active material including a metal and an oxide of the metal; and carbon in such an amount that the total absorption number thereof is at least 4.7 ml per mol of the raw active material, in which the kneaded mixture includes no sulfate or a sulfate in an amount of 7×10⁻² mol or smaller per mol of the raw active material.

A negative-electrode active material for a secondary battery according to claim 2 of the present invention is provided in which in claim 1, the negative-electrode active material has a specific volume of 2.2×10⁻¹ to 5×10⁻¹ ml/g with subjected to no formation after filled into a grid-shaped current collector and dried.

A negative-electrode active material for a secondary battery according to claim 3 of the present invention is provided in which in claim 1 or 2, the carbon is acetylene black.

A negative-electrode active material for a secondary battery according to claim 4 of the present invention is provided in which in claim 3, the kneaded mixture further includes polyvinyl alcohol having a weight ratio of 5×10⁻² or higher to the acetylene black and having a solubility of 4×10⁻¹ or lower to water at 20° C.

A negative-electrode active material for a secondary battery according to claim 5 of the present invention is provided in which in claim 1 or 2, the carbon is furnace carbon, and the kneaded mixture includes the carbon in a percentage of 1.27 mol or lower per mol of the raw active material.

A negative-electrode active material for a secondary battery according to claim 6 of the present invention is provided in which in any of claims 1 to 5, the kneaded mixture further includes silica.

A negative-electrode active material for a secondary battery according to claim 7 of the present invention is provided in which in claim 1 or 2: a first kneaded mixture is produced in a first kneading process of kneading the carbon together with polyvinyl alcohol and water or dilute sulfuric acid; a second kneaded mixture is produced in a second kneading process of further kneading the first kneaded mixture after the raw active material is added thereto; and the kneaded mixture is the second kneaded mixture.

A negative-electrode active material for a secondary battery according to claim 8 of the present invention is provided in which in claim 7, silica is further included to conduct the kneading in the first kneading process.

In order to improve the utilization of a negative-electrode active material for a secondary battery, the present invention realizes a configuration capable of bringing an electrolyte (dilute sulfuric acid) sufficiently into contact with the active material and causing no rise in the electric resistance. Specifically, the negative-electrode plate is formed with an electrically-conductive network having numerous pores for carrying an electrolyte, thereby heightening the specific volume of the negative-electrode plate. In other words, the porosity is raised to increase the quantity of the electrolyte inside of the negative-electrode plate and facilitate the percolation and diffusion of the electrolyte from the outside of the negative-electrode plate, thereby supplying a sufficient quantity of the electrolyte to the active material. Specifically, in a kneaded mixture of the negative-electrode active material, the total absorption number of carbon is designed to be at least 4.7 ml per mol of a raw active material (having a metal and an oxide of the metal).

The negative-electrode plate includes carbon as a particle-chained structure material to thereby form the electrically-conductive network. The particle-chained structure material is a material formed by melting and attaching a plurality of particles to each other and extending in a chain shape over the whole. This carbon is dispersed into water or dilute sulfuric acid and kneaded after given lead powder as the raw active material to thereby create the negative-electrode active material which is the kneaded mixture in paste form. Preferably, the kneaded mixture may have a specific volume of 2.2×10⁻¹ to 5×10⁻¹ ml/g with subjected to no formation after filled into a grid as a current collector of the negative-electrode plate and dried.

In the kneaded mixture, the lead powder as the raw active material is substantially uniformly dispersed in the electrically-conductive network formed with the carbon and arranged inside of the electrically-conductive network. The carbon as the particle-chained structure material intertwines crisscross to thereby shape a network and simultaneously form a porous structure having numerous pores retaining a sufficient quantity of the electrolyte. Besides, the carbon maintains an excellent electrical conductivity. At the time of a discharge, the dilute sulfuric acid stored in the pores is continuously supplied to the dispersed raw active material, and thereby, the electrically-conductive network prevents the electric resistance from rising sharply immediately before the discharge ends.

Silica, though not conductive, can also form a porous structure having an absorption number substantially equal to that of carbon, and thereby, has the same effect in the absorption and diffusion of an electrolyte even if a part of the carbon is replaced with silica. In a practical example described later, silica is increased in a specified quantity while carbon is decreased in the same quantity in such a way that both have the same absorption number to thereby measure a contribution to the utilization. However, both of them need not necessarily have the same absorption number and may take a mutually different absorption number, as long as the sum thereof becomes a desired absorption number to secure the porous structure.

Furthermore, in the present invention, the sulfate (SO₄) inside of a kneaded mixture is reduced, or no sulfate is contained therein, thereby preventing the particle diameter of lead powder as a raw active material from being larger to keep the raw active material with the particle diameter remaining small. An active material made of a raw active material having a small particle diameter is capable of smoothing a discharge and having a higher active-material utilization while conducting the discharge. If a sulfate is contained, the amount thereof is set to an amount of 7×10⁻² mol or smaller per mol of the raw active material. The sulfate originates from dilute sulfuric acid generally employed as a kneading medium in creating a kneaded mixture of the negative-electrode active material. In the present invention, the particle diameter of each lead-oxide containing particle of a raw active material contained in the created negative-electrode active material becomes smaller than any conventional art, thereby keeping diffusing an electrolyte stably to the active material to smooth a discharge. This makes it possible to realize a significant improvement in the utilization of the active material while conducting the discharge.

In further detail, although each particle of lead powder (if one particle is microscopically seen, 75 to 80% of the particle is oxidized while the center thereof and its vicinity not oxidized) as the material has a diameter of approximately 1 μm and is extremely fine, if a sulfate is added thereto, then the lead-oxide part thereof changes into tribasic lead sulfate (3PbO.PbSO₄.H₂O) and thereby the particle diameter becomes larger. Then, this is treated in a curing process, thereby enlarging the particle diameter further. The sulfate inside of the kneaded mixture is restricted to reduce or nullify the formation amount of tribasic lead sulfate, thereby keeping each lead-oxide containing particle of the raw active material small as a whole.

In this way, a particle-chained structure material is contained to thereby enhance the porosity of a negative-electrode active material and promote the supply of an electrolyte, and sulfates inside of a paste kneaded mixture is restricted to thereby prevent the particle diameter of a raw active material from being larger in a creation process. The synergy thereof enables the utilization of a negative-electrode active material to exceed 70% regarded as a theoretical limit up to date, which is nearly double a conventional ordinary utilization of 40% in a low-rate discharge conventional and approximately double that of a high-rate discharge.

As the carbon, acetylene black is preferable to furnace carbon because the former tends to have a higher utilization.

In addition, polyvinyl alcohol functions as a dispersant for a kneaded mixture while securing the electrical conductivity of carbon and improves the adhesive property of a negative-electrode paste to an electrode plate. If acetylene black is used as the carbon, preferably, kneading may be conducted by containing polyvinyl alcohol having a weight ratio of 5×10⁻² or higher to the acetylene black and having a solubility of 4×10⁻¹ or lower to water at 20° C. The polyvinyl alcohol is relatively inexpensive, thereby obtaining a higher active-material utilization than any prior art, without raising material costs.

If furnace carbon is used as the carbon, it is contained in a percentage of 1.27 mol or lower per mol of the raw active material, thereby obtaining a higher active-material utilization than any prior art.

In the present invention, the negative-electrode active material has carbon (occasionally, silica as a part) added thereto and preferably polyvinyl alcohol dispersed as a dispersant thereto to form a kneaded mixture in paste form with sulfates restricted, thereby significantly improving the utilization of the active material. The present invention is capable of obtaining an active-material utilization approximately twice as high as that of any prior art, thereby almost halving the amount of lead powder as a raw active material necessary for realizing a desired battery capacity, as compared with any prior art.

The reduction in the amount of lead powder further lowers the cost of a storage battery and enhances the energy density largely, and consequently, the weight of a conventional storage battery can be reduced in the case of the same battery capacity. Therefore, the negative-electrode active material according to the present invention is extremely suitable for a hybrid-automobile storage battery and an electric automobile. Although it has been infeasible over nearly the past hundred years to significantly improve the utilization of an active material, the present invention accomplishes the object for the first time, and hence, the industrial value thereof can be said to be extremely high.

Moreover, the negative-electrode active material according to the present invention is useful for manufacturing a lead storage battery having a charge-and-discharge cycle life remarkably superior to those of conventional ones.

### BRIEF DESCRIPTION OF THE DRAWINGS

FIG. 1 is a graphical representation showing a result of a low-rate 0.06A discharge in a relationship between the specific volume and utilization of a negative-electrode active material according to the present invention.

FIG. 2 is a graphical representation showing a result of a high-rate 6A discharge in the relationship between the specific volume and utilization of the negative-electrode active material according to the present invention.

FIG. 3 is a graphical representation showing a result of a low-rate 0.06A discharge in a relationship between the specific volume and capacity of the negative-electrode active material according to the present invention.

FIG. 4 is a graphical representation showing a result of a high-rate 6A discharge in the relationship between the specific volume and capacity of the negative-electrode active material according to the present invention.

FIG. 5 is a graphical representation showing a result of a low-rate 0.06A discharge in a relationship between the carbon absorption number and utilization of the negative-electrode active material according to the present invention.

FIG. 6 is a graphical representation showing a result of a high-rate 6A discharge in the relationship between the carbon absorption number and utilization of the negative-electrode active material according to the present invention.

FIG. 7 is a graphical representation showing a result of a low-rate 0.06A discharge in a relationship between the sulfate amount and utilization of the negative-electrode active material according to the present invention.

FIG. 8 is a graphical representation showing a result of a high-rate 6A discharge in the relationship between the sulfate amount and utilization of the negative-electrode active material according to the present invention.

FIG. 9 is a graphical representation showing a result of a low-rate 0.06A discharge in a relationship between the silica amount and utilization of the negative-electrode active material according to the present invention.

FIG. 10 is a graphical representation showing a result of a high-rate 6A discharge in the relationship between the silica amount and utilization of the negative-electrode active material according to the present invention.

FIG. 11 is a graphical representation showing each of a low-rate discharge (0.06A) and a high-rate discharge (6A) in a relationship between the polyvinyl-alcohol addition amount and utilization of the negative-electrode active material according to the present invention.

FIG. 12 is a graphical representation showing a utilization at a 0.06A low-rate discharge in a relationship between the carbon amount and utilization of the negative-electrode active material according to the present invention.

FIG. 13 is a graphical representation showing a utilization at a 6A high-rate discharge in the relationship between the carbon amount and utilization of the negative-electrode active material according to the present invention.

FIG. 14 is a graphical representation showing a life-test result of the negative-electrode active material according to the present invention and a conventional negative-electrode active material.

### DETAILED DESCRIPTION OF THE INVENTION

First, an embodiment of the present invention will be summarized, and the details thereof described in each practical example described below.

A negative-electrode active material for a secondary battery (simply called the “negative-electrode active material” or “active material”) according to the present invention is practically applied for a lead storage battery. The negative-electrode active material contains a raw active material as the main component thereof and other necessary components to become a kneaded mixture in paste form. The kneaded mixture is filled into a negative-electrode plate as a grid-shaped current collector and dried (with subjected to no formation), and thereafter, the negative-electrode plate is embedded in a storage battery and undergoes formation to thereby complete a lead storage battery.

The kneaded mixture as the negative-electrode active material includes a raw active material containing a metal and an oxide of the metal, and carbon. The raw active material is lead powder and the carbon is contained in such an amount that the total absorption number thereof is at least 4.7 ml per mol of the raw active material. In a relationship in relative content between the carbon contained in the active material and the raw active material, “the total absorption number” is equal to the whole absorption number (shown in detail in an arithmetic expression described later) of the carbon in a carbon content per mol of the raw active material and is a value different from a dibutylphthalate absorption number as an index of carbon characteristics. As a kneading medium, only water (without dilute sulfuric acid) or dilute sulfuric acid is used, and if dilute sulfuric acid is used, a sulfate (SO₄) contained therein is set to a percentage of 7×10⁻² mol or smaller per mol of the raw active material.

The negative-electrode active material according to the present invention has, as a standard porosity thereof, a specific volume of 2.2×10⁻¹ to 5×10⁻¹ ml/g with subjected to no formation after filled into a grid-shaped current collector and dried.

Even if a part of the carbon is replaced with silica in the above kneaded mixture, the same advantage of the present invention can be obtained. When carbon and silica are mixed, however, in order to obtain substantially the same advantage as that in the case of carbon alone, preferably, the replacement may be conducted in such a way that the total absorption number is approximately equal to that in the case of carbon alone.

As the carbon, for example, acetylene black or furnace carbon, or a mixture thereof may be used, and in the case of acetylene black, the utilization of an active material is higher than that of furnace carbon. When furnace carbon is used, if it is contained in a percentage of 1.27 mol or lower per mol of a raw active material, the active-material utilization becomes higher than any conventional one.

Furthermore, it is preferable that the above kneaded mixture contains polyvinyl alcohol (PVA). Polyvinyl alcohol is added mainly to improve the dispersion property of carbon or the like, and also contributes to, when the kneaded mixture is filled into a grid-shaped current collector, raising the adhesive strength thereof. Particularly, when acetylene black is used, polyvinyl alcohol having a dissolution amount of 4×10¹ g (a solubility of 4×10⁻¹) or lower in water of 100 g at 20° C. is contained in a weight ratio of 5×10⁻² or higher to the acetylene black, thereby obtaining an active-material utilization higher than any conventional one.

Moreover, polyvinyl alcohol having a dissolution amount of 38 g (a solubility of 3.8×10⁻¹) or lower in water of 100 g at 20° C. is inexpensive and hence suitable. On the other hand, it is found out that polyvinyl alcohol having a dissolution amount of 12 g (a solubility of 1.2×10⁻¹) or lower in water of 100 g at 20° C. has no effect on the utilization of an active material, even though the addition amount is comparatively increased.

The negative-electrode active material according to the present invention is produced in the following manufacturing process (i.e., process of creating a kneaded mixture). In a first kneading process, carbon is kneaded together with polyvinyl alcohol and water or dilute sulfuric acid to thereby produce a first kneaded mixture. Next, in a second kneading process, the first kneaded mixture is further kneaded after the raw active material is added thereto to thereby produce a second kneaded mixture which is the above negative-electrode active material. Conventionally, a negative-electrode active material has not been kneaded in two such processes. However, the present invention is capable of obtaining the negative-electrode active material having a desired specific volume through the two kneading processes. Further, the first kneading process can be replaced by a stirring means or the like.

The utilization of the negative-electrode active material according to the present invention is, if a grid-shaped current collector is employed, approximately 70% in a 40-hour rate discharge (low-rate discharge) and approximately 40% in a 10-minute rate discharge (high-rate discharge). In terms of either discharge rate of the low-rate discharge and the high-rate discharge, the utilization is far higher than any conventional lead storage battery. As the current collector, an ordinary grid can be employed, or a sheet such as a lead sheet may be used and the active material applied thereto. If filled into the grid-shaped current collector, the kneaded mixture is changed into paste form by decreasing the quantity of water as a kneading medium to the other components because it needs to have a certain viscosity. On the other hand, if applied to the sheet, the kneaded mixture is changed into slurry form by increasing the quantity of water to thereby lower the viscosity. Whether the kneaded mixture is paste or slurry before applied to an electrode plate, the advantages of the present invention can be obtained in the same way.

An electrode plate obtained by filling the paste into the grid-shaped current collector is basically suitable for all the uses of a conventional lead storage battery and is lighter than any other electrode plate having the same battery capacity. A lead storage battery including a sheet electrode plate can be formed into a cylindrical shape, and if the electrode plate is spirally wound, is excellent in a high-rate discharge and has a great resistance against violation. This lead storage battery is suitable especially for a hybrid automobile and an electric automobile. Although a nickel-hydrogen battery or a lithium-ion battery is now used or studied for a hybrid automobile, either of them is expensive. The lead storage battery according to the present invention has a far lower cost, and hence, is more practical.

As described above, the lead storage battery provided with the negative-electrode active material according to the present invention can discharge with a large quantity of electric current, has a long life, a high utilization of the active material and a low cost, and can manage a charge-and-discharge more easily than a lithium-ion battery or a nickel-hydrogen battery. The lead storage battery is most suitably applied to a hybrid use of the engine and storage battery of an automobile by charging the storage battery with regenerative electric power when braking and utilizing electric power from the storage battery when starting, thereby reducing the consumption of gasoline. The automobile industry has focused and will focus its efforts on environment-friendly hybrid cars capable of saving energy or reducing exhaust gas, thereby extremely enhancing the industrial applicability of the present invention.

In addition, an ordinary storage battery is frequently used for a float charge which is a system supplying electric power to loads from the storage battery in an emergency of electric-service interruption, usually by discharging at an approximately 10-minute rate. If a conventional lead storage battery is employed as this storage battery, it discharges in a short time or with a large quantity of electric current, thereby further deteriorating the active-material utilization originally not so high rated. This requires a lead storage battery having a large rated capacity which is large and heavy. The lead storage battery provided with the negative-electrode active material according to the present invention has an active-material utilization approximately twice or more times as high as any conventional lead storage battery and is capable of discharging with a large quantity of electric current to lighten the weight.

Each practical example of the present invention will be below described in the case where it is applied to a negative-electrode plate provided with a grid-shaped current collector.

### Practical Example 1

In Practical Example 1, a kneaded mixture (below called “negative-electrode paste”) as a negative-electrode active material having varied specific volumes is prepared, the negative-electrode paste is filled into a grid-shaped current collector to thereby form a negative-electrode plate, and a test is given to the negative-electrode plate.

### <Sample Preparation>

Table 1 shows the component composition of each negative-electrode paste served in the test.

TABLE 1

| | Component | | Component | | | Component | |
|---|---|---|---|---|---|---|---|
| | 1 | Component | 3 | Component | Component | 6 | Component |
| | Lead | 2 | Barium | 4 | 5 | Polyvinyl | 7 |
| | Powder (g) | Lignin (g) | Sulfate (g) | Carbon (g) | Graphite (g) | alcohol (g) | Water (g) |
| Negative- | 200 | 0.7 | 0.7 | 0 | 0 | 0 | 19 |
| electrode | | | | | | | |
| Paste 1 | | | | | | | |
| Negative- | 200 | 0.7 | 0.7 | 0 | 0 | 0 | 17 |
| electrode | | | | | | | |
| Paste 2 | | | | | | | |
| Negative- | 200 | 0.7 | 0.7 | 0 | 0 | 0 | 21 |
| electrode | | | | | | | |
| Paste 3 | | | | | | | |
| Negative- | 200 | 0.7 | 0.7 | 2.9 | 17.1 | 0.3 | 60 |
| electrode | | | | | | | |
| Paste 4 | | | | | | | |
| Negative- | 200 | 0.7 | 0.7 | 2.9 | 17.1 | 0.3 | 66 |
| electrode | | | | | | | |
| Paste 5 | | | | | | | |
| Negative- | 200 | 0.7 | 0.7 | 8.6 | 11.4 | 0.9 | 72 |
| electrode | | | | | | | |
| Paste 6 | | | | | | | |
| Negative- | 200 | 0.7 | 0.7 | 8.6 | 11.4 | 0.9 | 80 |
| electrode | | | | | | | |
| Paste 7 | | | | | | | |
| Negative- | 200 | 0.7 | 0.7 | 8.6 | 11.4 | 0.9 | 88 |
| electrode | | | | | | | |
| Paste 8 | | | | | | | |
| Negative- | 200 | 0.7 | 0.7 | 11.4 | 8.6 | 1.1 | 100 |
| electrode | | | | | | | |
| Paste 9 | | | | | | | |
| Negative- | 200 | 0.2 | 0.4 | 0 | 0 | 0 | 37(*) |
| electrode | | | | | | | |
| Paste 10 | | | | | | | |

(*)Component 7 of Negative-electrode Paste 10 indicates the weight of dilute sulfuric acid having a specific gravity of 1.15.

Lead powder is the main component of the active material and has a lead oxidation degree of approximately 75 to 80%, carbon is acetylene black having a dibutylphthalate absorption number of 175 ml/100 g, graphite has an average particle diameter of approximately 13 μm and polyvinyl alcohol (by Kuraray Co.) has a polymerization degree of 2400.

The dibutylphthalate absorption number indicates the amount of dibutyl phthalate absorbed per 100 g of the material and is an index expressing a liquid absorbency of the material. Herein, it is used as the parameter of a specific volume which is a property of the electrode plate provided with the negative-electrode active material. In the practical examples of the present invention, the dibutylphthalate absorption number or the above total absorption number reduced based upon this is clearly related to the active-material utilization or the battery capacity to thereby clarify the relationship between the characteristics of the negative-electrode active material according to the present invention and the utilization or the battery capacity thereof. The specific volume is controlled using carbon, graphite and the quantity of water.

In the case where carbon and graphite are used (Negative-electrode Pastes 4 to 9), first, these are kneaded together with water and polyvinyl alcohol for thirty minutes, and thereafter, the kneaded mixture is given lead powder, lignin and barium sulfate and further kneaded for thirty minutes.

In Negative-electrode Pastes 1 to 3 and 10 created as comparative examples, lead powder, lignin and barium sulfate are simply kneaded in amounts shown in Table 1. In Negative-electrode Paste 10, however, not water but dilute sulfuric acid generally employed is used, which corresponds to a conventional negative-electrode active material.

### <Test Method>

The thus created Negative-electrode Pastes 4 to 9 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. In the same way, Negative-electrode Pastes 1 to 3 and 10 as the comparative examples are filled into the grid-shaped current collector.

In terms of the thus obtained negative-electrode plates subjected to no formation, a specific volume indicating one of the characteristics of a negative-electrode active material is measured in a method shown in Table 2.

TABLE 2

| | | |
|---|---|---|
| 1 | Measure grid weight. | A |
| 2 | Immerse grid in water, reduce pressure to vacuum, extract and place grid | |
| | against wall, remove surface water, lightly wipe water adhering to grid | |
| | bottom and measure weight. | |
| 3 | Immerse grid again in water, measure grid buoyancy and set it to grid | B |
| | volume. | |
| 4 | Measure weight of electrode plate subjected to no formation. | C |
| 5 | Immerse electrode plate in water, reduce pressure to vacuum, extract and | |
| | place electrode plate against wall, remove surface water, lightly wipe | |
| | water adhering to electrode-plate bottom and measure weight. | |
| 6 | Immerse electrode plate again in water, measure electrode plate buoyancy | D |
| | and set it to electrode-plate volume. | |

The specific volume of an active material subjected to no formation is calculated in the following expression.

Specific volume of active material subjected to no formation=Volume of active material subjected to no formation/Weight of active material subjected to no formation=(D−B)/(C−A)

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A (amperes) and 6A: 0.06A is a low-rate discharge at an approximately 40-hour rate and 6A is a high-rate discharge at an approximately 10-minute rate. The cut-off voltages of discharge are 1.7V (volts) and 1.2V per cell, respectively, and the temperature is 25° C.

### <Test Result>

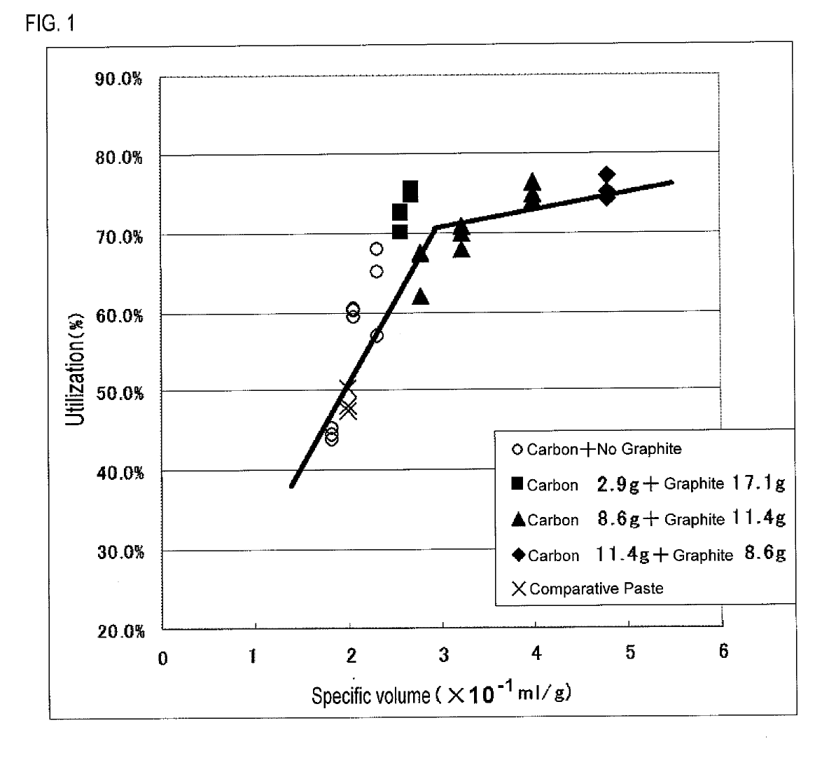

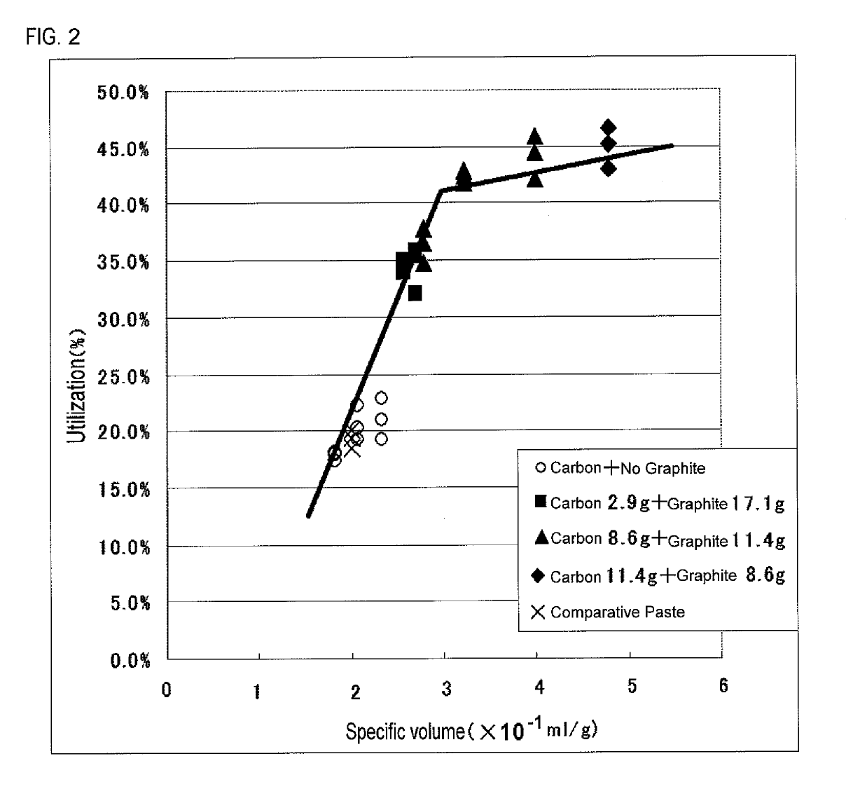

In the relationship between the specific volume of an active material subjected to no formation and the utilization, FIG. 1 and FIG. 2 are each a graphical representation showing a result of the low-rate 0.06A discharge and a result of the high-rate 6A discharge, respectively. The low-rate discharge utilization of FIG. 1 and the high-rate discharge utilization of FIG. 2 both rise sharply as the specific volume rises at or below 3×10⁻¹ ml/g. Above 3×10⁻¹ ml/g, on the other hand, in both FIG. 1 and FIG. 2, the utilization rises gently as the specific volume rises.

The Negative-electrode Pastes 4 to 9 according to the present invention all have a specific volume of 2.5×10⁻¹ ml/g or higher, and hence, a utilization of 60 to 78% is obtained in the low-rate discharge while 32 to 47% in the high-rate discharge. In Negative-electrode Paste 10 conventionally employed, the specific volume is approximately 2×10⁻¹ ml/g and the utilization is approximately 50% in the low-rate discharge and approximately 20% in the high-rate discharge, which are almost equal to conventionally-known utilization upper limits. Further, Negative-electrode Pastes 1 to 3 not containing carbon and graphite without using dilute sulfuric acid have higher utilizations than Negative-electrode Paste 10, if the former have higher specific volumes than the latter, while they have lower utilizations than Negative-electrode Pastes 4 to 9 including carbon and graphite according to the present invention.

If the specific volume is lower, a larger quantity of electrolyte (dilute sulfuric acid) necessary for a discharge of the active material needs to be supplied from the outside of the electrode plate while if the specific volume is higher, the electrolyte can be supplied from near the active material, thereby making the discharge easier, which produces the results of FIG. 1 and FIG. 2. The utilization is an indispensable item for improving the energy density of a battery, and if the utilization is higher, the battery active material can be reduced, thereby cutting down on expenses.

As can be seen from the results of FIG. 1 and FIG. 2, it is most efficient to keep the specific volume slightly higher than 3×10⁻¹ ml/g. This is because the utilization will not rise so much even if the specific volume is raised beyond this.

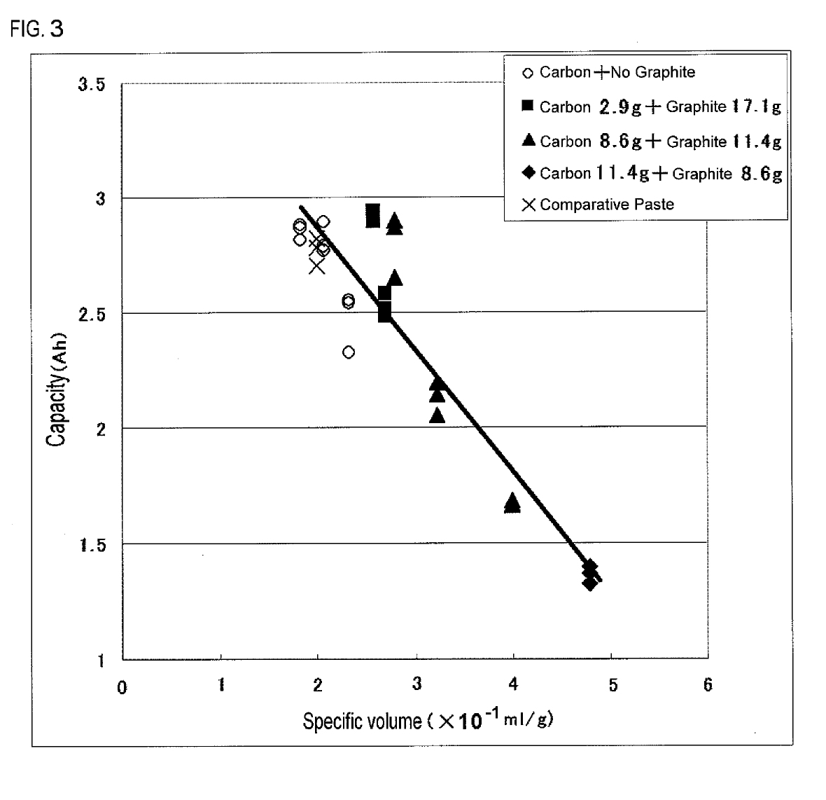

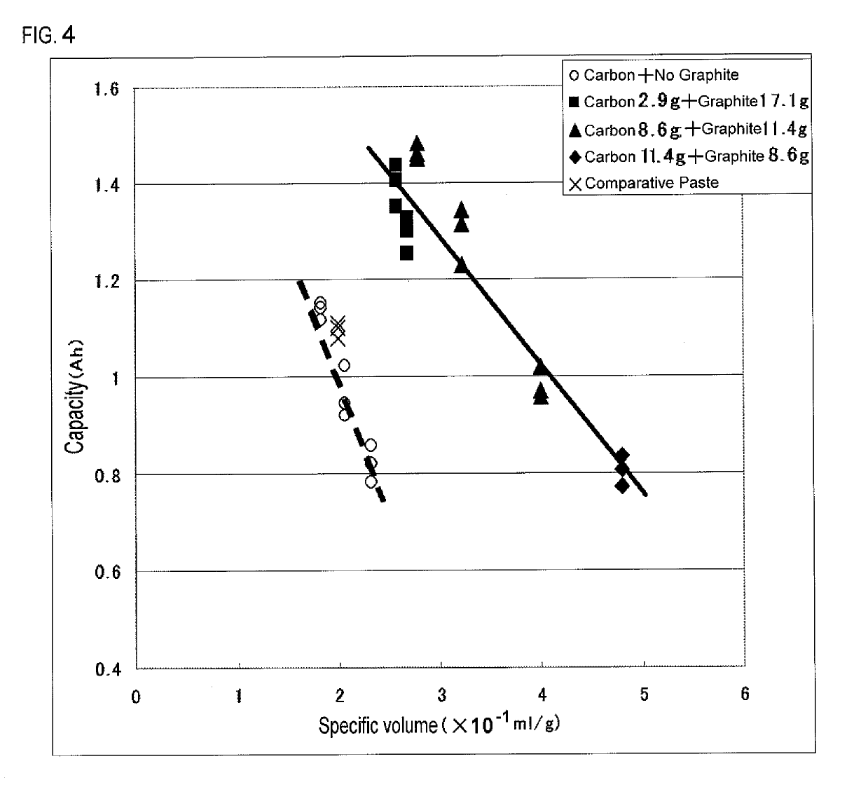

As described above, although the utilization is an essential element, the absolute capacity of a battery is occasionally required for some uses. FIG. 3 is a graphical representation showing a result of a low-rate 0.06A discharge in a relationship between the specific volume and capacity of an active material subjected to no formation, and FIG. 4 is a graphical representation showing a result of a high-rate 6A discharge. In FIG. 3, the low-rate discharge capacity decreases monotonously as the specific volume rises. This is because the higher the specific volume becomes, the less the active material becomes, thereby causing a reduction in the capacity to be extracted. In the high-rate discharge of FIG. 4, the capacity decreases as the specific volume rises, and in the cases where there are carbon and graphite, the capacities are higher than the cases where there are no such carbon because the electrical conductivity or good liquid-retention properties of carbon and graphite are thought to have contributed to the increase in the capacity of the high-rate discharge.

Conventionally, the specific volume of an active material subjected to no formation is approximately 2×10⁻¹ ml/g. Judging from the results of FIG. 1 and FIG. 2, preferably, in order to improve the utilization, the specific volume of the active material subjected to no formation may be approximately 2.2×10⁻¹ ml/g or higher. As can be seen from the results of FIG. 3 and FIG. 4, however, in order to retain the absolute capacity to a certain extent, it is realistic to set the specific volume to 5×10⁻¹ ml/g or lower. This is because in FIG. 1 and FIG. 2, the highest utilization is obtained around a specific volume of 5×10⁻¹ ml/g which is a range practical enough for the AND condition of the utilization and the specific volume.

As described earlier, the lead powder as a raw active material is mainly a lead oxide, but contains metallic lead not oxidized. The lead oxide reacts with sulfuric acid as an electrolyte to form lead as an active material through formation, and the thus formed lead is usually regarded as the active material. If so, whether the originally-contained metallic lead should be regarded as the active material is a matter of controversy. Probably, the metallic lead would function as the active material fairly less than the lead oxide. However, the metallic lead originally contained in the raw active material is considered here to function as the active material in the same way as the lead oxide, and the utilization of the active material in a discharge is calculated. If the metallic lead does not contribute much to the utilization, the utilization of the active material according to the present invention becomes a higher value than this practical example. The same is applied to the other practical examples as well.

### Practical Example 2

In Practical Example 2, a negative-electrode paste containing carbon having varied dibutylphthalate absorption numbers is prepared, the negative-electrode paste is filled into a grid-shaped current collector to thereby form a negative-electrode plate, and a test is given to the negative-electrode plate.

### <Sample Preparation>

Table 3 shows the component composition of each negative-electrode paste served in the test.

TABLE 3

| | | | | Component | | | |
|---|---|---|---|---|---|---|---|
| | | | | 4 | | | |
| | Component | | Component | Carbon | | Component | |
| | 1 | Component | 3 | Absorption | Component | 6 | Component |
| | Lead | 2 | Barium | Number | 5 | Polyvinyl | 7 |
| | Powder (g) | Lignin (g) | Sulfate (g) | (ml/100 g) | Graphite (g) | Alcohol (g) | Water (g) |
| Negative- | 200 | 0.7 | 0.7 | 175 | 11.4 | 1 | 80 |
| electrode | | | | | | | |
| Paste 7 | | | | | | | |
| Negative- | 200 | 0.7 | 0.7 | 80 | 11.4 | 1 | 39 |
| electrode | | | | | | | |
| Paste 11 | | | | | | | |
| Negative- | 200 | 0.7 | 0.7 | 140 | 11.4 | 1 | 66 |
| electrode | | | | | | | |
| Paste 12 | | | | | | | |
| Negative- | 200 | 0.7 | 0.7 | 220 | 11.4 | 1 | 96 |
| electrode | | | | | | | |
| Paste 13 | | | | | | | |
| Negative- | 200 | 0.2 | 0.4 | — | 0 | 0 | 37(*) |
| electrode | | | | | | | |
| Paste 10 | | | | | | | |

(*)Component 7 of Negative-electrode Paste 10 indicates the weight of dilute sulfuric acid having a specific gravity of 1.15.

Lead powder is the main component of the active material and has an oxidation degree of approximately 75 to 80%. As shown in Table 3, carbon is acetylene black having four absorption numbers of 80, 140, 175 and 220 ml/100 g, graphite has an average particle diameter of approximately 13 μm and polyvinyl alcohol (by Kuraray Co.) has a polymerization degree of 2400. The section of Component 4 in Table 3 shows the dibutylphthalate absorption numbers of carbon, and the amount thereof is 8.6 g in all the cases.

In Practical Example 1 described above, the specific volume is controlled using carbon, graphite and the quantity of water. In Practical Example 2, however, the carbon dibutylphthalate absorption number is varied to thereby control the specific volume of the kneaded mixture.

In the case where carbon and graphite are used (Negative-electrode Pastes 7, 11 to 13), first, these are kneaded together with water and polyvinyl alcohol for thirty minutes, and thereafter, the kneaded mixture is given lead powder, lignin and barium sulfate and further kneaded for thirty minutes.

In Negative-electrode Paste 10 created as a comparative example, lead powder, lignin and barium sulfate are simply kneaded in the amounts shown in Table 1, and not water but dilute sulfuric acid generally employed is used.

### <Test Method>

The thus created Negative-electrode Pastes 7, 11 to 13 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. In the same way, Negative-electrode Paste 10 as the comparative example is filled into the grid-shaped current collector.

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A and 6A: 0.06A is a low-rate discharge at an approximately 40-hour rate and 6A is a high-rate discharge at an approximately 10-minute rate. The cut-off voltages of discharge are 1.7V and 1.2V per cell, respectively, and the temperature is 25° C.

### <Test Result>

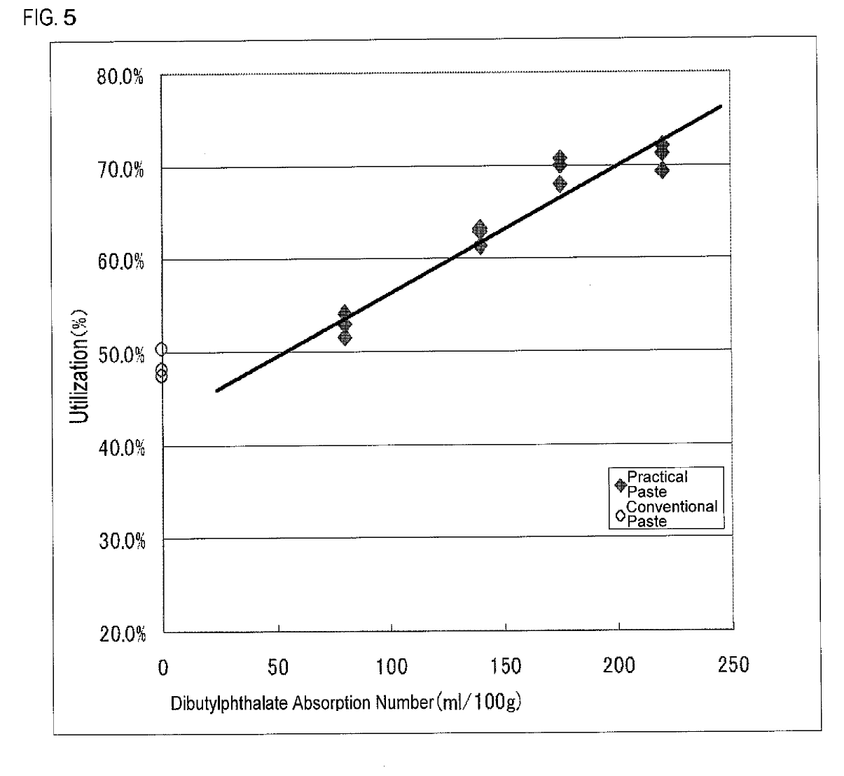

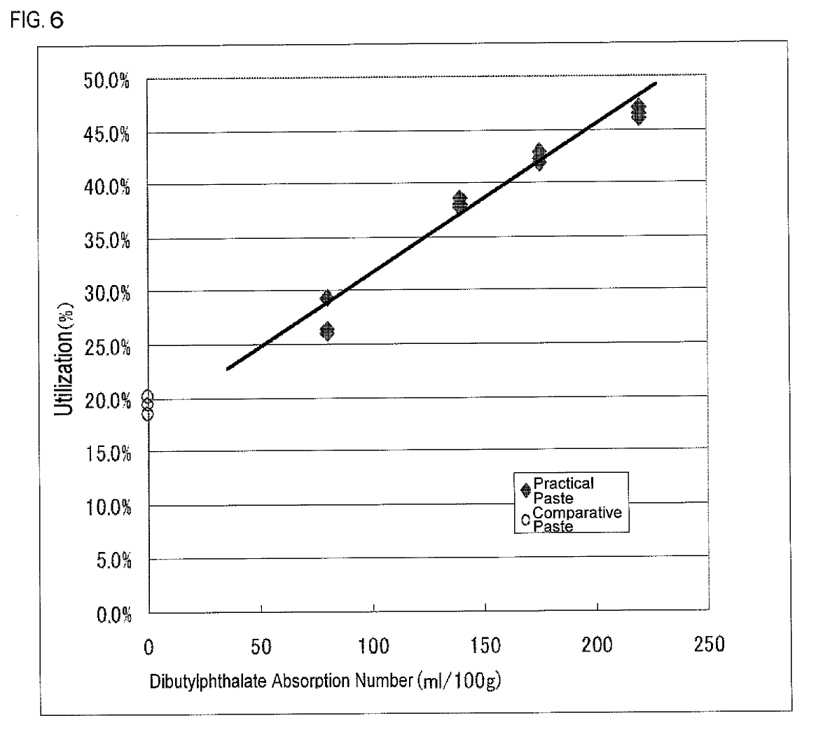

In the relationship between the dibutylphthalate absorption number of carbon and the utilization, FIG. 5 and FIG. 6 are graphical representations showing a result of a low-rate 0.06A discharge and a result of a high-rate 6A discharge, respectively (in the figures, “practical paste” corresponds to Negative-electrode Pastes 11 to 13 according to the present invention and “comparative paste” corresponds to Negative-electrode Paste 10 of the comparative example, and the same is applied to the following figures). Around an absorption number of 50 ml/100 g, the utilization exceeds a conventional ordinary utilization of 40% by approximately 10% and is equal to or a little more than a utilization of 50% of the conventional paste used for the test herein, while at an absorption number of 80 ml/100 g or more, the utilization becomes further higher than the conventional paste in both the low-rate discharge and the high-rate discharge. In the above practical example, it is found out that carbon raises the specific volume of the negative-electrode paste. As can be seen from the result of Practical Example 2, the dibutylphthalate absorption number of carbon also raises the specific volume of the negative-electrode paste, thereby improving the utilization of the negative electrode. Hence, it is found out that the same operation and advantages can be obtained.

With reference to FIG. 6, the utilization exceeds the utilization of the conventional paste by approximately 5% near a lower-limit value of 50 ml/100 g of the dibutylphthalate absorption number in the high-rate discharge. At a dibutylphthalate absorption number of 50 ml/100 g, the total absorption number of the contained carbon 8.6 g is 50 (ml/100 g)×8.6 g=4.3 ml. If this value is reduced to an absorption number per mol of lead powder as the raw active material employed here, then as described above, the lead powder has an oxidation degree of approximately 75 to 80%, and hence, an example will be described in the case where a lead-oxide component is 75% and a lead component is 25%.

The lead powder 200 g used here is composed of the lead oxide 150 g and the metallic lead 50 g. The lead oxide has a molecular weight of 223 and hence is 150/223=0.673 (mol) and the metallic lead has a molecular weight of 207 and thereby is 50/207=0.242 (mol), thereby making the total number of moles of the lead powder 0.673+0.242=0.915 (mol).

Since the total absorption number of the carbon to the lead powder 0.915 mol is 4.3 ml, the absorption number reduced per mol is 4.3 ml/0.915(mol)=4.699(ml/mol). This description is expressed by the following arithmetic expression (in the above calculation, the numeric values are rounded off at each stage for convenience, but the calculation made all at once in the single arithmetic expression is as follows).

50(ml/100 g)×8.6(g)/(150(g)/223+50(g)/207)=4.704(ml/mol)

If the lead-oxide component is 80% and the lead component is 20%, the calculation is made in the following expression.

50(ml/100 g)×8.6(g)/(160(g)/223+40(g)/207)=4.722(ml/mol)

Therefore, in FIG. 5 showing the utilization of the low-rate discharge and FIG. 6 showing the utilization of the high-rate discharge, if the total absorption number of the carbon is at least 4.7 ml per mol of the raw active material (i.e., the carbon is contained in such an amount that the total absorption number thereof is at least 4.7 ml per mol of the raw active material), the utilization becomes higher than that of the conventional paste.

### Practical Example 3

In Practical Example 3, a negative-electrode paste containing sulfates in varied amounts is prepared, the negative-electrode paste is filled into a grid-shaped current collector to thereby form a negative-electrode plate, and a test is given to the negative-electrode plate.

### <Sample Preparation>

Table 4 shows the component composition of each negative-electrode paste served in the test.

TABLE 4

| | Component | | Component | | | Component | | Component |
|---|---|---|---|---|---|---|---|---|
| | 1 | Component | 3 | Component | Component | 6 | Component | 8 |
| | Lead | 2 | Barium | 4 | 5 | Polyvinyl | 7 | Amount of |
| | Powder (g) | Lignin (g) | Sulfate (g) | Carbon (g) | Graphite (g) | Alcohol (g) | Water (g) | Sulfates (g) |
| Negative- | 200 | 0.7 | 0.7 | 8.6 | 11.4 | 1 | 80 | 0 |
| electrode | | | | | | | | |
| Paste 14 | | | | | | | | |
| Negative- | 200 | 0.7 | 0.7 | 8.6 | 11.4 | 1 | 80 | 2.9 |
| electrode | | | | | | | | |
| Paste 15 | | | | | | | | |
| Negative- | 200 | 0.7 | 0.7 | 8.6 | 11.4 | 1 | 80 | 5.7 |
| electrode | | | | | | | | |
| Paste 16 | | | | | | | | |
| Negative- | 200 | 0.2 | 0.4 | 0 | 0 | 0 | 37(*) | 7.8 |
| electrode | | | | | | | | |
| Paste 10 | | | | | | | | |

(*)Component 7 of Negative-electrode Paste 10 indicates the weight of dilute sulfuric acid having a specific gravity of 1.15.

Lead powder is the main component of the active material and has a lead oxidation degree of approximately 75 to 80%, carbon is acetylene black having a dibutylphthalate absorption number of 220 ml/100 g, graphite has an average particle diameter of approximately 13 μm and polyvinyl alcohol (by Kuraray Co.) has a polymerization degree of 2400.

Negative-electrode Paste 14 contains no sulfates while Negative-electrode Pastes 15 and 16 contains sulfates in the amounts shown in Component a of Table 4.

Negative-electrode Paste 10 as a comparative example is an example of negative-electrode paste conventionally employed and includes dilute sulfuric acid in an amount of 32 ml (approximately 37 g) having a specific gravity of 1.15 as Component 7. This is equivalent to sulfates in an amount of 7.8 g (shown in Component 8 of Table 4) which are contained in the dilute sulfuric acid in an amount of 37 g.

In the case where carbon and graphite are used (Negative-electrode Pastes 14 to 16), first, these are kneaded together with water (dilute sulfuric acid in Pastes 15 and 16) and polyvinyl alcohol for thirty minutes, and thereafter, the kneaded mixture is given lead powder, lignin and barium sulfate and further kneaded for thirty minutes.

In Negative-electrode Paste 10 created as a comparative example, lead powder, lignin and barium sulfate are simply kneaded in the amounts shown in Table 4, and not water but dilute sulfuric acid is used as described above.

### <Test Method>

The thus created Negative-electrode Pastes 14 to 16 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. In the same way, Negative-electrode Paste 10 as the comparative example is filled into the grid-shaped current collector.

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A and 6A: 0.06A is a low-rate discharge at an approximately 40-hour rate and 6A is a high-rate discharge at an approximately 10-minute rate. The cut-off voltages of discharge are 1.7V and 1.2V per cell, respectively, and the temperature is 25° C.

### <Test Result>

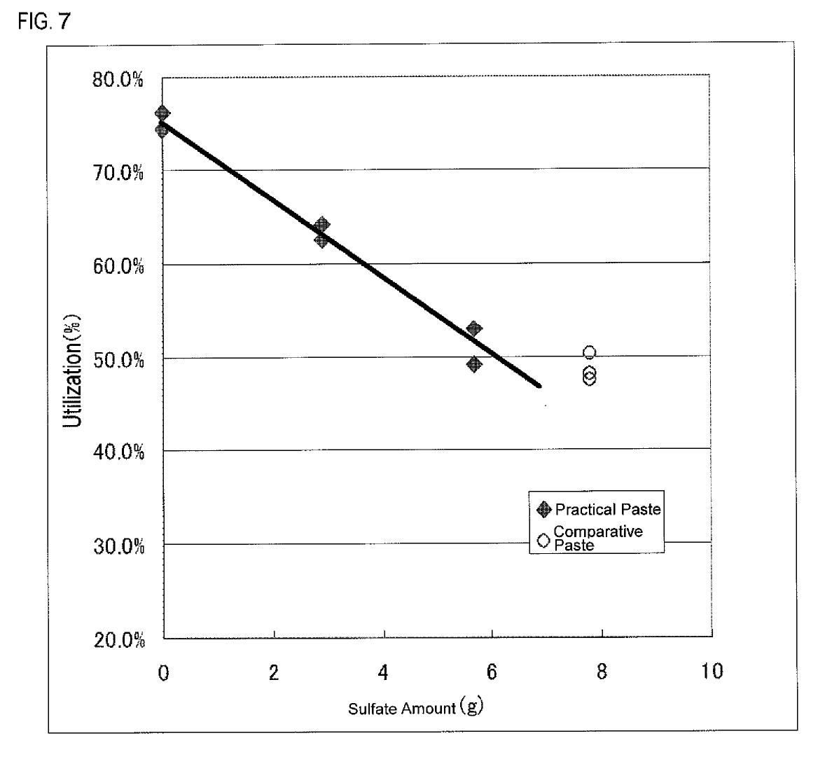

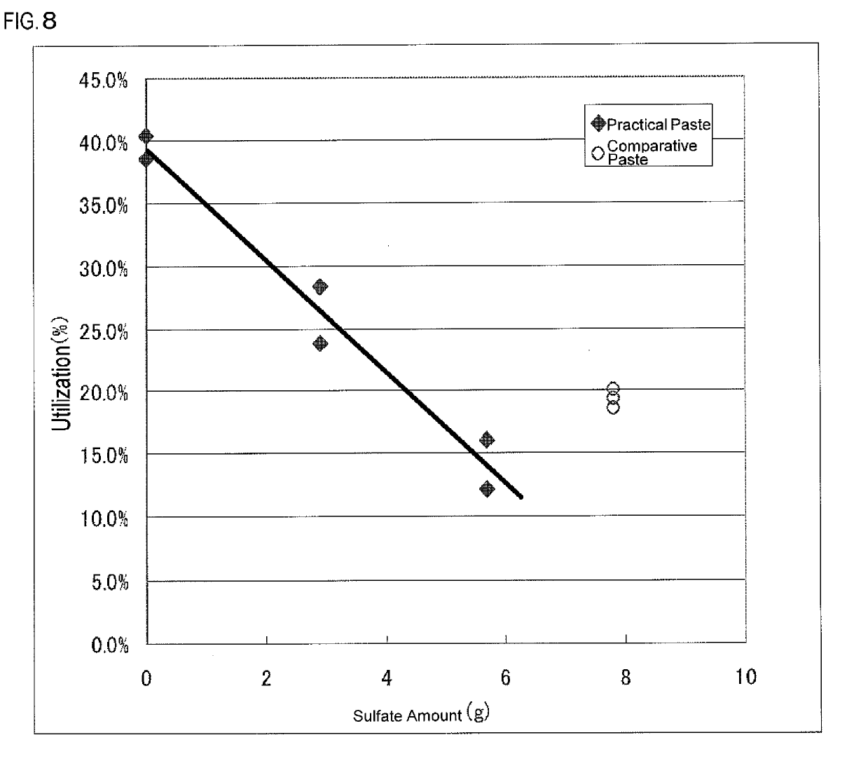

In the relationship between the amount of sulfates and the utilization, FIG. 7 and FIG. 8 are graphical representations showing a result of a low-rate 0.06A discharge and a result of a high-rate 6A discharge, respectively. In both the low-rate discharge and the high-rate discharge, the utilization is highest if there are no sulfates, and the larger the amount of sulfates becomes, it becomes lower. In terms of the amount of sulfates, the upper-limit value is a point having a higher utilization than any conventional paste, and hence, is about 6 g in the low-rate discharge and about 4 g in the high-rate discharge. Therefore, the upper-limit value of sulfates coming from dilute sulfuric acid can be set to 6 g in the low-rate discharge. The upper-limit value of sulfates to a raw active material is calculated as follows. The sulfates 6 g has a molecular weight of 96 and is 0.063 mol(6(g)/96=0.063(mol)), and hence, the molar ratio to the lead powder 200 g (0.91 mol) is 0.063/0.919=6.9×10⁻². In short, it is found out that a higher utilization than any conventional one can be obtained if the sulfates are contained in an amount of 7×10⁻² mol or smaller per mol of the raw active material.

Conventionally, all negative-electrode pastes contain dilute sulfuric acid, and the sulfates coming from dilute sulfuric acid changes a lead oxide—the main component of lead powder—into tribasic lead sulfate in a kneading process, thereby enlarging the size of a crystal. This undergoes formation to thereby form a negative-electrode active material having a larger particle, thereby substantially reducing the contact surface area of the active material with an electrolyte to lower the utilization.

In Practical Example 3, dilute sulfuric acid is used, but alternatively, for example, a sodium-sulfate aqueous solution or a potassium-surface aqueous solution may be used to create a similar kneaded mixture. It has been verified that if the sulfates are increased, then in the same way, the utilization of a negative-electrode active material deteriorates.

### Practical Example 4

A negative-electrode paste containing silica in varied amounts is prepared, the negative-electrode paste is filled into a grid-shaped current collector to thereby form a negative-electrode plate, and a test is given to the negative-electrode plate.

### <Sample Preparation>

Table 5 shows the component composition of each negative-electrode paste served in the test.

TABLE 5

| | Component | | Component | | | | Component | Component |
|---|---|---|---|---|---|---|---|---|
| | 1 | Component | 3 | Component | Component | Component | 7 | 8 |
| | Lead | 2 | Barium | 4 | 5 | 6 | Polyvinyl | Amount of |
| | Powder (g) | Lignin (g) | Sulfate (g) | Carbon (g) | Graphite (g) | Silica (g) | alcohol (g) | Sulfates (g) |
| Negative- | 200 | 0.7 | 0.7 | 10 | 14 | 0 | 1.4 | 0 |
| electrode | | | | | | | | |
| Paste 17 | | | | | | | | |
| Negative- | 200 | 0.7 | 0.7 | 7 | 14 | 3 | 0.7 | 0 |
| electrode | | | | | | | | |
| Paste 18 | | | | | | | | |
| Negative- | 200 | 0.7 | 0.7 | 3 | 14 | 7 | 0.9 | 0 |
| electrode | | | | | | | | |
| Paste 19 | | | | | | | | |
| Negative- | 200 | 0.2 | 0.4 | 0 | 0 | 0 | 0 | 7.8 |
| electrode | | | | | | | | |
| Paste 10 | | | | | | | | |

Lead powder is the main component of the active material and has a lead oxidation degree of approximately 75 to 80%, carbon is acetylene black having a dibutylphthalate absorption number of 170 ml/100 g, graphite has an average particle diameter of approximately 13 μm and polyvinyl alcohol (by Kuraray Co.) has a polymerization degree of 2400. In terms of carbon and silica, a part of the carbon is replaced with silica in such a way that the absorption number is the same to thereby prepare the pastes shown in Table 5. As a comparative example, a test is given to Negative-electrode Paste 10 conventionally employed which is shown in Table 1.

In Negative-electrode Pastes 17 to 19, carbon, graphite and silica (if contained) are kneaded together with water and polyvinyl alcohol for thirty minutes, and thereafter, the kneaded mixture is given lead powder, lignin and barium sulfate and further kneaded for thirty minutes. In Negative-electrode Paste 10 of the comparative example, the same kneading as the above practical examples is conducted.

### <Test Method>

The thus created Negative-electrode Pastes 17 to 19 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. In the same way, Negative-electrode Paste 10 as the comparative example is filled into the grid-shaped current collector.

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A and 6A: 0.06A is a low-rate discharge at an approximately 40-hour rate and CA is a high-rate discharge at an approximately 10-minute rate. The cut-off voltages of discharge are 1.7V and 1.2V per cell, respectively, and the temperature is 25° C.

### <Test Result>

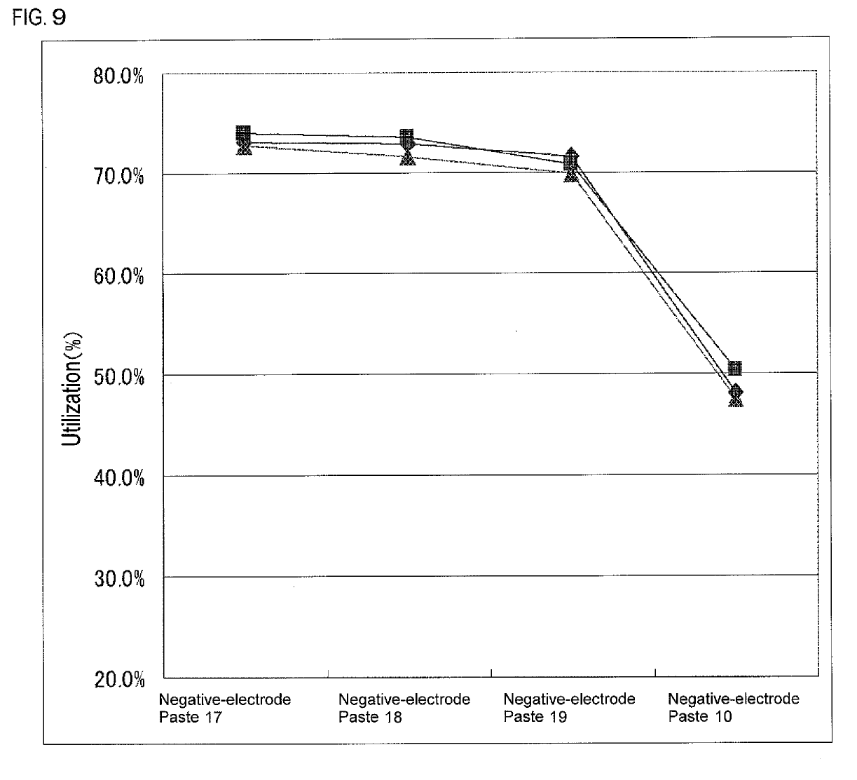

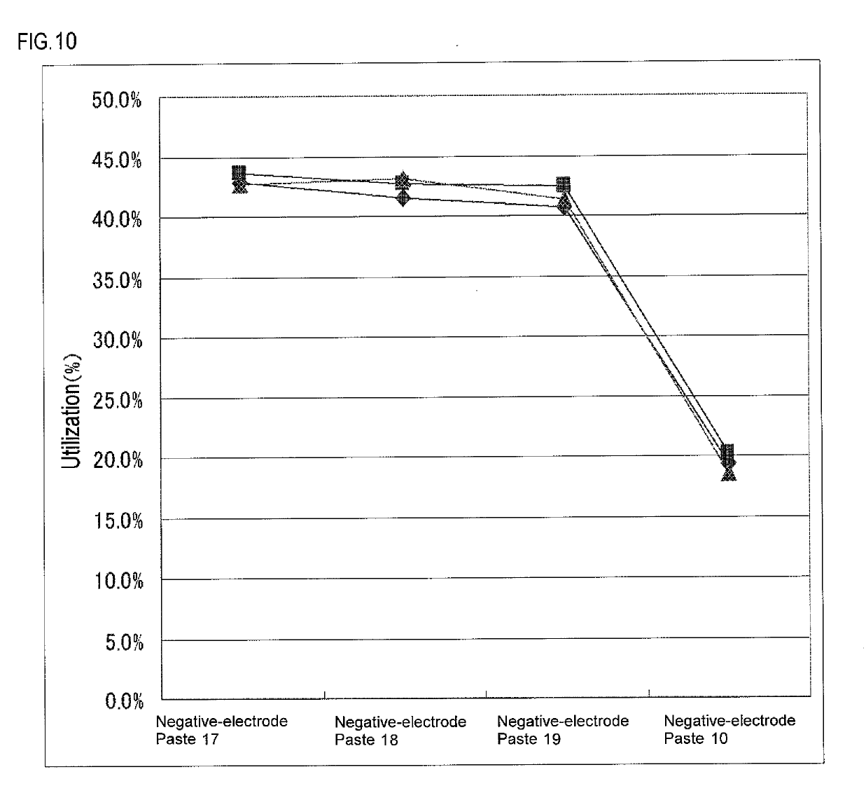

In the relationship between the amount of silica and the utilization, FIG. 9 and FIG. 10 are graphical representations showing a result of a low-rate 0.06A discharge and a result of a high-rate &A discharge, respectively. In the low-rate 0.05A discharge, Negative-electrode Pastes 17 to 19 have a utilization of 72 to 74% higher than 48% in Negative-electrode Paste 10 as the comparative example, and even if a part of the carbon is replaced with silica, substantially the same utilization can be obtained.

In the high-rate 6A discharge, Negative-electrode Pastes 17 to 19 have a utilization of 42 to 44% which is also higher than 19% in Negative-electrode Paste 10 as the comparative example, and even if a part of the carbon is replaced with silica, substantially the same utilization can be obtained.

Since silica has a dibutylphthalate absorption number as high as that of carbon, the active-material utilization remains high even if silica is substituted for a part of the carbon. On the other hand, if a part of the carbon is replaced with silica having a different dibutylphthalate absorption number, then the amount of silica and/or the absorption number of silica can be adjusted in such a way that the total absorption number per mol of a raw active material is the same as the case of carbon alone, thereby securing almost the same absorption number.

### Practical Example 5

A negative-electrode paste containing polyvinyl alcohol in varied amounts is prepared, the negative-electrode paste is filled into a grid-shaped current collector to thereby form a negative-electrode plate, and a test is given to the negative-electrode plate. Polyvinyl alcohol is added as a dispersant for carbon or graphite.

### <Sample Preparation>

Table 6 shows the component composition of each negative-electrode paste served in the test.

TABLE 6

| | Component | | Component | | | Component | Component |
|---|---|---|---|---|---|---|---|
| | 1 | Component | 3 | Component | Component | 6 | 7 |
| | Lead | 2 | Barium | 4 | 5 | Polyvinyl | Polyvinyl |
| | Powder (g) | Lignin (g) | Sulfate (g) | Carbon (g) | Graphite (g) | Alcohol-1 (g) | Alcohol-2 (g) |
| Negative- | 200 | 0.7 | 0.7 | 8.6 | 11.4 | 0.86 | |
| electrode | | | | | | | |
| Paste 20 | | | | | | | |
| Negative- | 200 | 0.7 | 0.7 | 8.6 | 11.4 | 1.71 | |
| electrode | | | | | | | |
| Paste 21 | | | | | | | |
| Negative- | 200 | 0.7 | 0.7 | 8.6 | 11.4 | 2.57 | |
| electrode | | | | | | | |
| Paste 22 | | | | | | | |
| Negative- | 200 | 0.7 | 0.7 | 8.6 | 11.4 | 3.43 | |
| electrode | | | | | | | |
| Paste 23 | | | | | | | |
| Negative- | 200 | 0.7 | 0.7 | 8.6 | 11.4 | | 0.86 |
| electrode | | | | | | | |
| Paste 24 | | | | | | | |
| Negative- | 200 | 0.7 | 0.7 | 8.6 | 11.4 | | 1.71 |
| electrode | | | | | | | |
| Paste 25 | | | | | | | |
| Negative- | 200 | 0.7 | 0.7 | 8.6 | 11.4 | | 2.57 |
| electrode | | | | | | | |
| Paste 26 | | | | | | | |

Lead powder is the main component of the active material and has a lead oxidation degree of approximately 75 to 80%, carbon is acetylene black having a dibutylphthalate absorption number of 220 ml/100 g and graphite has an average particle diameter of approximately 13 μm.

As the polyvinyl alcohol are used polyvinyl alcohol (Exceval RS-4105 by Kuraray Co.) having a relatively low solubility to water, and polyvinyl alcohol (by Kuraray Co.) which is common and has a relatively high solubility to water. The former is polyvinyl alcohol-1 and the latter is polyvinyl alcohol-2.

In Negative-electrode Pastes 20 to 26, carbon and graphite are kneaded together with water and polyvinyl alcohol for thirty minutes, and thereafter, the kneaded mixture is given lead powder, lignin and barium sulfate and further kneaded for thirty minutes.

The thus created Negative-electrode Pastes 20 to 26 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. The polyvinyl alcohol-1 has a solubility of 12 percent at 20° C. and the polyvinyl alcohol-2 has a solubility of 38 percent at 20° C. The solubility is a threshold limit value to which a specified solute is dissolved in a certain quantity of solvent, and in view of easier understanding thereof in this embodiment, it is expressed by a percentage as Solubility=(Solute mass(g)/Solvent mass(g))×100%. In Claims, however, it is expressed simply as Solubility=(Solute mass(g)/Solvent mass (g).

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A and 6A: 0.06A is a low-rate discharge at an approximately 40-hour rate and 6A is a high-rate discharge at an approximately 10-minute rate. The cut-off voltages of discharge are 1.7V and 1.2V per cell, respectively, and the temperature is 25° C.

### <Test Result>

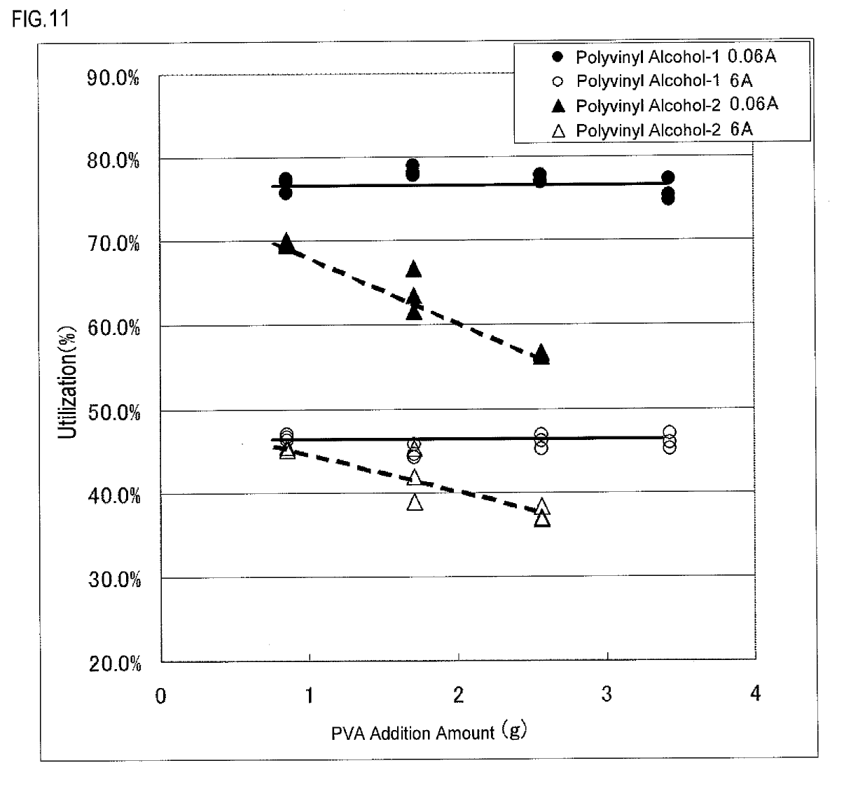

FIG. 11 is a graphical representation showing each of a high-rate discharge (6A) and a low-rate discharge (0.06A) in the relationship between the polyvinyl-alcohol addition amount and the utilization. In terms of the polyvinyl alcohol-2 having a high solubility, the larger the polyvinyl-alcohol addition amount becomes, the lower the active-material utilization becomes in either of the low-rate discharge and the high-rate discharge. In terms of the polyvinyl alcohol-1 having a low solubility, even if the addition amount is increased, the active-material utilization remains unchanged.

The upper-limit value of the addition amount of the polyvinyl alcohol-2 is, as can be seen in FIG. 11, appropriately considered to be a point where an active-material utilization (2.57 g in Negative-electrode Paste 26) is obtained of almost 55% or above in the low-rate discharge and almost 35% or above in the high-rate discharge. The weight ratio thereof to acetylene black (8.6 g) at the point is calculated as 2.57 (g)/8.6(g)=0.299 which is substantially equal to 3×10⁻¹. In brief, it is preferable to add the polyvinyl alcohol-2 in such a way that the weight ratio thereof to the acetylene black stays at or below 3×10⁻¹.

In addition, the polyvinyl alcohol-2 has a solubility of 38 percent at 20° C. and polyvinyl alcohol in general (including the polyvinyl alcohol-1 and the polyvinyl alcohol-2) may appropriately have a solubility of 40 percent or below (i.e., a solubility of 4×10⁻¹ or lower to water at 20° C.)

Polyvinyl alcohol has an intrinsic object of improving the dispersion property of carbon or graphite while securing the electrical conductivity of the carbon, and because of the adhesion performance thereof, also has the function of raising the adhesive strength to a grid-shaped current collector when negative-electrode paste is filled into the grid-shaped current collector. In this case, although the addition amount of polyvinyl alcohol needs to be increased to enhance the adhesive strength, the low-solubility polyvinyl alcohol-1 is suitable because the utilization can be prevented from deteriorating even though the addition amount is raised.

### Practical Example 6

A negative-electrode paste containing varied carbons is prepared, the negative-electrode paste is filled into a grid-shaped current collector to thereby form a negative-electrode plate, and a test is given to the negative-electrode plate. In addition, a test is given to a negative-electrode paste containing polyvinyl alcohol in a different addition amount to those carbons.

### <Sample Preparation>

Table 7 shows the component composition of each negative-electrode paste served in the test.

TABLE 7

| | Component | | Component | Component | Component | | Component | | Percentage |
|---|---|---|---|---|---|---|---|---|---|
| | 1 | Component | 3 | 4 | 5 | Component | 7 | Component | of Polyvinyl |
| | Lead | 2 | Barium | Acetylene | Furnace | 6 | Polyvinyl | 8 | Alcohol to |
| | Powder (g) | Lignin (g) | Sulfate (g) | Black (g) | Carbon (g) | Graphite (g) | alcohol (g) | Water (g) | Carbon (%) |
| Negative- | 200 | 0.7 | 0.7 | 11.4 | | 5 | 0.57 | 74 | 5 |
| electrode | | | | | | | | | |
| Paste 27 | | | | | | | | | |
| Negative- | 200 | 0.7 | 0.7 | | 10.6 | 5 | 0.53 | 70 | 5 |
| electrode | | | | | | | | | |
| Paste 28 | | | | | | | | | |
| Negative- | 200 | 0.7 | 0.7 | 11.4 | | 5 | 1.14 | 74 | 10 |
| electrode | | | | | | | | | |
| Paste 29 | | | | | | | | | |
| Negative- | 200 | 0.7 | 0.7 | | 10.6 | 5 | 1.06 | 70 | 10 |
| electrode | | | | | | | | | |
| Paste 30 | | | | | | | | | |
| Negative- | 200 | 0.7 | 0.7 | 22.8 | | 5 | 1.14 | 133 | 5 |
| electrode | | | | | | | | | |
| Paste 31 | | | | | | | | | |
| Negative- | 200 | 0.7 | 0.7 | | 21.2 | 5 | 1.06 | 124 | 5 |
| electrode | | | | | | | | | |
| Paste 32 | | | | | | | | | |
| Negative- | 200 | 0.7 | 0.7 | 22.8 | | 5 | 2.28 | 131 | 10 |
| electrode | | | | | | | | | |
| Paste 33 | | | | | | | | | |
| Negative- | 200 | 0.7 | 0.7 | | 21.2 | 5 | 2.12 | 123 | 10 |
| electrode | | | | | | | | | |
| Paste 34 | | | | | | | | | |

Lead powder is the main component of the active material and has a lead oxidation degree of approximately 75 to 80%. In order to make a comparison between the kinds, carbons are an acetylene black having a dibutylphthalate absorption number of 170 ml/100 g and a furnace carbon having a dibutylphthalate absorption number of 185 ml/100 g. Graphite has an average particle diameter of approximately 13 μm and polyvinyl alcohol (by Kuraray Co.) has a polymerization degree of 2400. In this embodiment, a comparison test is given in the cases where polyvinyl alcohol has a weight ratio of 5×10⁻² and 1×10⁻¹ to the carbon.

In Negative-electrode Pastes 27 to 34, carbon and graphite are kneaded together with water and polyvinyl alcohol for thirty minutes, and thereafter, the kneaded mixture is given lead powder, lignin and barium sulfate and further kneaded for thirty minutes.

The thus created Negative-electrode Pastes 20 to 26 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm. The polyvinyl alcohol used in this practical example embodiment is the polyvinyl alcohol-2 of Practical Example 5 and has the same solubility as Practical Example 5.

Next, a fine glass-fiber separator is brought into contact with both sides of the single negative-electrode plate, and further, one positive-electrode plate is brought into contact with each outside thereof. According to this configuration, the theoretical capacity of the active material becomes extremely excessive in the positive electrode, thereby making it possible to evaluate the utilization of the objective negative electrode (i.e., active material thereof). The electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320.

Thereafter, the electrode-plate group inserted into the battery container is subjected to a capacity test using the two of 0.06A and 6A: 0.06A is a low-rate discharge at an approximately 40-hour rate and 6A is a high-rate discharge at an approximately 10-minute rate. The cut-off voltages of discharge are 1.7V and 1.2V per cell, respectively, and the temperature is 25° C.

### <Test Result>

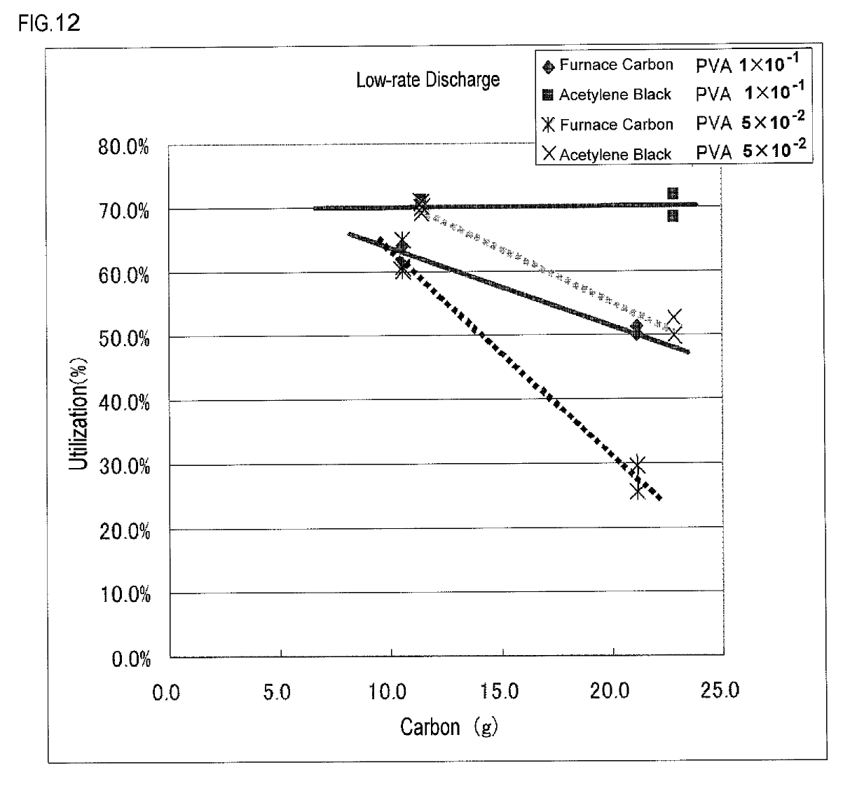

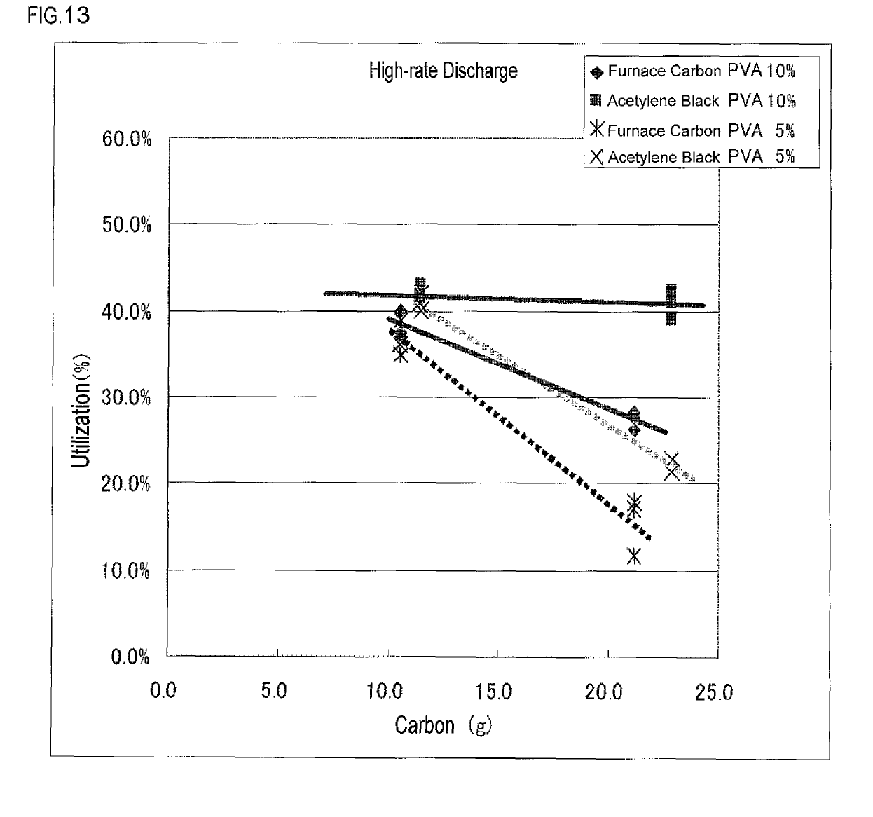

In the relationship between the amount of carbon and the utilization, FIG. 12 and FIG. 13 are graphical representations showing a result of a 0.06A low-rate discharge and a result of a 6A high-rate discharge, respectively.

The relationships between the kind of carbon and the amount of polyvinyl alcohol, and the utilization, are as follows.

If coexisting with polyvinyl alcohol having a weight ratio of 1×10⁻¹ to the carbon, regardless of the amount of carbon, the acetylene black maintains the same utilization in both the low-rate discharge and the high-rate discharge. In contrast, the furnace carbon deteriorates the utilization if the carbon amount becomes larger, though maintaining substantially the same utilization as the acetylene black if it becomes smaller.

If coexisting with polyvinyl alcohol having a weight ratio of 5×10⁻² to the carbon, the acetylene black and the furnace carbon both deteriorates the utilization if the carbon amount becomes larger, but the acetylene black lowers the utilization less than the furnace carbon.

The polyvinyl alcohol used in this practical example embodiment is the polyvinyl alcohol-2 of Practical Example 5, and FIG. 12 and FIG. 13 indicate a lower-limit value of the addition amount of the polyvinyl alcohol-2 when the acetylene black is used. In the case of the acetylene black, even if the addition amount of the polyvinyl alcohol-2 to the content of the acetylene black is either 5×10⁻² or 1×10⁻¹ in weight ratio, an active-material utilization of 50% or above and 20% or above can be obtained in the low-rate discharge and in the high-rate discharge, respectively. Therefore, when the acetylene black is used, if the polyvinyl alcohol-2 is added in an amount equivalent to a weight ratio of 5×10⁻² to the acetylene black, this amount can be set as the lower-limit value. In the polyvinyl alcohol-1, as shown in FIG. 11 of Practical Example 5, naturally, the polyvinyl alcohol-1 contributes to improving the utilization more than the polyvinyl alcohol-2, and thereby, the equivalent of the polyvinyl alcohol-1 to a weight ratio of 5×10⁻² to the acetylene black can also be set as the lower-limit value.

Furnace carbon is less expensive than acetylene black add hence advantageous from the viewpoint of costs. In the case of furnace carbon, with reference to FIG. 12 and FIG. 13, if the furnace carbon is set to 14 g or below, the utilization becomes higher than the conventional paste (Negative-electrode Paste 10 of Table 1) shown in FIG. 1 and FIG. 2. At this time, the utilization is approximately 50% in the low-rate discharge of FIG. 12 and approximately 30% in the high-rate discharge of FIG. 13. As shown in FIG. 1 and FIG. 2, this exceeds the utilization of the conventional paste by approximately 48% in the low-rate discharge and by approximately 20% in the high-rate discharge. In short, the content of polyvinyl alcohol equivalent to a weight ratio of 5×10⁻² to acetylene black is set as the lower-limit value, thereby verifying the superiority of the present invention.

Accordingly, furnace carbon 14 g is suitable for lead powder 200 g (0.919 mol). Furnace carbon has a molecular weight of 12, and hence, the molar amount thereof per mol of the lead powder is calculated as (14(g)/12)/0.919=1.2695 (mol). In other words, if the furnace carbon is 1.27 mol or below per mol of the lead powder, it can be practically employed.

Furthermore, it is found out that acetylene black can be used without restricting the molar ratio thereof for the lead powder (within the test range).

### Practical Example 7

A negative-electrode paste according to the present invention and a conventional negative-electrode paste are subjected to a life test in a charge-and-discharge cycle.

### <Sample Preparation>

Table 8 shows the component composition of each negative-electrode paste served in the test.

TABLE 8

| | | | | | | | | Component |
|---|---|---|---|---|---|---|---|---|
| | Component | | Component | | | Component | | 8 |
| | 1 | Component | 3 | Component | Component | 6 | Component | Concentrated |
| | Lead | 2 | Barium | 4 | 5 | Polyvinyl | 7 | Sulfuric |
| | Powder (g) | Lignin (g) | Sulfate (g) | Carbon (g) | Graphite (g) | Alcohol (g) | Water (g) | Acid (g) |
| Negative- | 200 | 0.7 | 0.7 | 8.6 | 11.4 | 1 | 80 | 0 |
| electrode | | | | | | | | |
| Paste 14 | | | | | | | | |
| Negative- | 200 | 0.35 | 0.35 | 0 | 0 | 0 | 76 | 7.8 |
| electrode | | | | | | | | |
| Paste 35 | | | | | | | | |

Negative-electrode Paste 14 according to the present invention is used in Practical Example 7 described above, and Negative-electrode Paste 35 which is conventional and not containing carbon has substantially the same specific volume as Negative-electrode Paste 14 by adjusting the quantity of water in Component 7. From the results of the above practical examples, it is thought that the negative-electrode paste according to the present invention has a higher utilization mainly because the specific volume or porosity thereof is higher than the conventional paste. However, it has been conventionally understood that the life shortens as the specific volume rises. Taking this into account, in this practical example, the same specific volume as the negative-electrode paste according to the present invention is used to thereby compare the lives of both pastes. Hence, Negative-electrode Paste 35 has a specific volume higher than a conventional negative-electrode paste generally employed.

In Table 8, the relationship between the quantity of water in Component 7 and the amount of concentrated sulfuric acid in Component 8 is as follows. Component 8 is concentrated sulfuric acid having a specific gravity of 1.8 and a mass of 7.8 g, and thereby, the volume is 7.8(g)/1.8(g/ml)=4.33(ml). This and water 76 g(=76 ml) in Component 7 are mixed to obtain 76(ml)+4.33(ml)=80.33(ml), and hence, the amount of concentrated sulfuric acid of Negative-electrode Paste 35 as the comparative example is 80.33 ml which is almost the same as the quantity of water 80 g(=80 ml) of Negative-electrode Paste 14.

In Negative-electrode Paste 14, carbon and graphite are kneaded together with water and polyvinyl alcohol for thirty minutes, and thereafter, the kneaded mixture is given lead powder, lignin and barium sulfate and further kneaded for thirty minutes. In Negative-electrode Paste 35 as the comparative example, lead powder, lignin and barium sulfate are simply kneaded together with dilute sulfuric acid (Components 7 and 8).

### <Test Method>

The thus created Negative-electrode Pastes 14 and 35 are filled into a grid-shaped current collector having a thickness of 2 mm, thereafter cured for twenty-four hours at a humidity of 98% and at a temperature of 45° C. and then dried for twenty-four hours at a temperature of 60° C. to thereby form negative-electrode plates having a thickness of 2.2 mm.

Next, a fine glass-fiber separator is brought into contact with both sides of the single negative-electrode plate, and further, one positive-electrode plate is brought into contact with each outside thereof. In the test, three positive-electrode plates and four negative-electrode plates are employed, the electrode-plate group is inserted into a battery container, and an ABS-resin spacer is loaded into the gap between the battery container and the electrode-plate group. Into the battery container, dilute sulfuric acid having a specific gravity of 1.223 is poured, and a quantity of electricity equivalent to 300% of the positive-electrode theoretical capacity is sent to thereby undergo formation. The specific gravity of an electrolyte after the formation is set to 1.320. Through the above process, a storage battery is created which has a capacity of 7A·h (ampere hour).

A life test repeating a charge-and-discharge cycle is given on the following conditions.

(a) Discharge: 7A.

(b) Discharge cut-off voltage: 1.5V/cell.

(c) Charge: 2.45V, 5 h.

The charging quantity is substantially 105% to the discharge quantity and the temperature is 25° C.

### <Test Result>

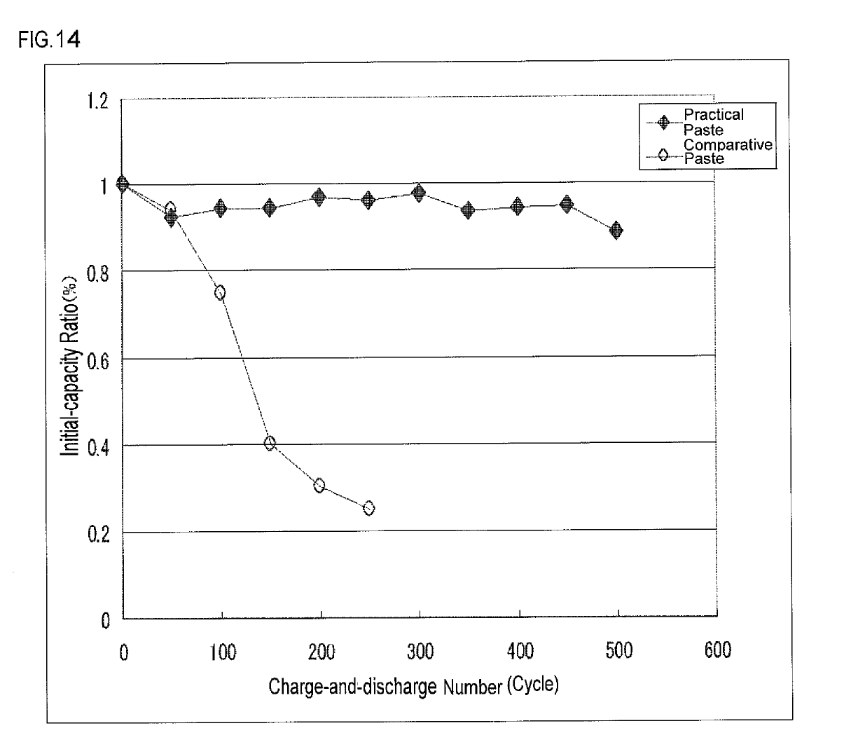

FIG. 14 is a graphical representation showing a life-test result, and the ordinate axis indicates the ratio to the initial capacity of the battery. Negative-electrode Paste 35 as the comparative example has a life of approximately 100 cycles while Negative-electrode Paste 14 according to the present invention has a life of 500 cycles or longer. Therefore, if a comparison is made at the same specific volume, Negative-electrode Paste 14 according to the present invention has a far longer life than Negative-electrode Paste 35 having the same component as the conventional paste. Although a general conventional paste has a lower specific volume and thereby has a longer life than Negative-electrode Paste 35, it has a life of merely 300 cycles or so. This proves that even if the specific volume is raised, the life of the negative-electrode paste according to the present invention is significantly improved without shortened. In Negative-electrode Paste 35 as the comparative example, because the specific volume is raised, the active material has more voids than the general conventional paste and thereby collapses more through the charge-and-discharge to shorten the life further.

In the negative-electrode paste according to the present invention, though the active material thereof has a higher specific volume, the carbon network supports porous active-material particles, thereby suppressing a collapse of the active material even if the charge-and-discharge is repeated, so that the life performance can be improved.

As described so far, the present invention is capable of making the cycle life performance of the storage battery far higher than any conventional storage battery. Conventionally, it has been thought that an enhancement in the utilization is inconsistent with an improvement in the cycle life performance, and hence, raising the utilization will inevitably deteriorate the cycle life performance. However, the present invention is capable of improving both at the same time.

1. A negative-electrode active material for a secondary battery which is a kneaded mixture, comprising:
a raw active material including a metal and an oxide of the metal; and
carbon in such an amount that the total absorption number thereof is at least 4.7 ml per mol of the raw active material,
wherein the kneaded mixture includes no sulfate or a sulfate in an amount of 7×10⁻² mol or smaller per mol of the raw active material.

2. A negative-electrode active material for a secondary battery which is a kneaded mixture comprising:
a raw active material including a metal and an oxide of the metal; and carbon,
wherein the negative-electrode active material has a specific density of 2.2×10⁻¹ to 5×10⁻¹ ml/g with subjected to no formation after filled into a grid-shaped current collector and dried.

3. The negative-electrode active material for a secondary battery according to claim 1, wherein the carbon is acetylene black.

4. The negative-electrode active material for a secondary battery according to claim 3, wherein the kneaded mixture further includes polyvinyl alcohol having a weight ratio of 5×10⁻² or higher to the acetylene black and having a solubility of 4×10⁻¹ or lower to water at 20° C.

5. The negative-electrode active material for a secondary battery according to claim 1, wherein the carbon is furnace carbon, and the kneaded mixture includes the carbon in a percentage of 1.27 mol or lower per mol of the raw active material.

6. The negative-electrode active material for a secondary battery according to claim 1, wherein the kneaded mixture further includes silica.

7. The negative-electrode active material for a secondary battery according to claim 1, wherein:
a kneading product is produced in a first kneading process of kneading the carbon together with one of polyvinyl alcohol and water, or dilute sulfuric acid;
an end kneaded mixture is produced in a second kneading process of further kneading the kneading product after the raw active material is added thereto; and
the kneaded mixture is the end kneaded mixture.

8. The negative-electrode active material for a secondary battery according to claim 7, wherein in the first kneading process, silica is further included to conduct the kneading.

9. The negative-electrode active material for a secondary battery according to claim 2, wherein the carbon is acetylene black.

10. The negative-electrode active material for a secondary battery according to claim 9, wherein the kneaded mixture further includes polyvinyl alcohol having a weight ratio of 5×10⁻² or higher to the acetylene black and having a solubility of 4×10⁻¹ or lower to water at 20° C.

11. The negative-electrode active material for a secondary battery according to claim 2, wherein the carbon is furnace carbon, and the kneaded mixture includes the carbon in a percentage of 1.27 mol or lower per mol of the raw active material.

12. The negative-electrode active material for a secondary battery according to claim 2, wherein the kneaded mixture further includes silica.

13. The negative-electrode active material for a secondary battery according to claim 2 wherein:
a kneading product is produced in a first kneading process of kneading the carbon together with one of polyvinyl alcohol and water, or dilute sulfuric acid;
an end kneaded mixture is produced in a second kneading process of further kneading the kneading product after the raw active material is added thereto; and
the kneaded mixture is the end kneaded mixture.

14. The negative-electrode active material for a secondary battery according to claim 13, wherein in the first kneading process, silica is further included to conduct the kneading.

15. A kneading product which is produced in a first kneading process and used for producing a secondary-battery negative-electrode composition formed of an end kneaded mixture, the end kneaded mixture comprising:
a raw active material including a metal and an oxide of the metal; and
carbon in such an amount that the total absorption number thereof is at least 4.7 ml per mol of the raw active material, and including sulfate in an amount between 0 and 7×10⁻² mol per mol of the raw active material, wherein,
the kneading product is kneaded after the raw active material is added thereto to thereby produce the end kneaded mixture, and the kneading product is produced by kneading the carbon together with one of polyvinyl alcohol and water, or dilute sulfuric acid.

16. (canceled)

17. A kneading product which is produced in a first kneading process and used for producing a secondary-battery negative-electrode composition formed of an end kneaded mixture, the end kneaded mixture comprising:
a raw active material including a metal and an oxide of the metal; and
carbon, and having a specific density of 2.2×10⁻¹ to 5×10⁻¹ ml/g with subjected to no formation after filled into a grid-shaped current collector and dried, wherein the kneading product is kneaded after the raw active material is added thereto to thereby produce the end kneaded mixture, and the kneading product is produced by kneading the carbon together with one of polyvinyl alcohol and water, or dilute sulfuric acid.

18. The negative-electrode active material for a secondary battery according to claim 3, wherein the kneaded mixture further includes silica.

19. The negative-electrode active material for a secondary battery according to claim 4, wherein the kneaded mixture further includes silica.

20. The negative-electrode active material for a secondary battery according to claim 5, wherein the kneaded mixture further includes silica.

21. The negative-electrode active material for a secondary battery according to claim 9, wherein the kneaded mixture further includes silica.

22. The negative-electrode active material for a secondary battery according to claim 10, wherein the kneaded mixture further includes silica.

23. The negative-electrode active material for a secondary battery according to claim 11, wherein the kneaded mixture further includes silica.

24. A kneading product which is produced in a first kneading process and used for producing a secondary-battery negative-electrode composition formed of an end kneaded mixture, the end kneaded mixture comprising:
a raw active material including a metal and an oxide of the metal;
carbon in such an amount that the total absorption number thereof is at least 4.7 ml per mol of the raw active material, and including sulfate in an amount between 0 and 7×10⁻² mol per mol of the raw active material; and
having a specific density of 2.2×10⁻¹ ml/g with subjected to no formation after filled into a grid-shaped current collector and dried, wherein,
the kneading product is kneaded after the raw active material is added thereto to thereby produce the end kneaded mixture, and the kneading product is produced by kneading the carbon together with one of polyvinyl alcohol and water, or dilute sulfuric acid.
